(19) United States
(12) Patent Application Publication
(10) Pub. No.: US 2025/0364748 A1
(43) Pub. Date: Nov. 27, 2025

(54) ELECTRICAL CONNECTOR ASSEMBLY

(71) Applicant: Lear Corporation, Southfield, MI (US)

(72) Inventors: Jordi Angel Serrano, Cologne (DE); Martin Komorniczak, Remscheid (DE); Xavier Farre Vives, Valls (ES); Yasin Canol, Remscheid (DE); Uemit Celiker, Schwelm (DE)

(73) Assignee: Lear Corporation, Southfield, MI (US)

(21) Appl. No.: 19/210,402

(22) Filed: May 16, 2025

(30) Foreign Application Priority Data
May 23, 2024 (DE) 10 2024 114 458.0

(51) Int. Cl. H01R 13/436; H01R 13/631

(52) U.S. Cl. CPC H01R 13/4368; H01R 13/631

(57) ABSTRACT

An electrical connector assembly, comprising: a first connector; a second connector connectable with the first connector; and a retainer slidably connectable to the first connector to restrict relative movement between the first connector and the second connector and to restrict relative movement between the first connector and a terminal. The retainer includes a retainer arm.

### CROSS-REFERENCE TO RELATED APPLICATIONS

This application claims the benefit of and priority to German Patent Application 10 2024 114 458.0, filed May 23, 2024, the disclosure of which is hereby incorporated by reference in its entirety as though fully set forth herein.

### TECHNICAL FIELD

The present disclosure generally relates to electrical connector assemblies, including electrical connector assembly that can, for example, be utilized for connecting wires with terminals.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of an electrical connector assembly according to teachings of the present disclosure.

FIG. 2 is an exploded view generally illustrating an embodiment of an electrical connector assembly according to teachings of the present disclosure.

FIG. 3 is a cross-sectional view generally illustrating an embodiment of an electrical connector assembly according to teachings of the present disclosure.

FIG. 4 is a perspective view generally illustrating an embodiment of a retainer of an electrical connector assembly according to teachings of the present disclosure.

FIG. 5 is a cross-sectional view generally illustrating an embodiment of a first connector of an electrical connector assembly according to teachings of the present disclosure.

FIG. 6 is a cross-sectional view generally illustrating an embodiment of a second connector of an electrical connector assembly according to teachings of the present disclosure.

FIGS. 7A, 7B, and 7C are perspective, first cross-sectional, and second cross-sectional views, respectively, generally illustrating an embodiment of an electrical connector assembly, with a retainer in a first retainer position, according to teachings of the present disclosure.

FIG. 8 is a cross-sectional view generally illustrating an embodiment of a first connector, a retainer, and a terminal of an electrical connector assembly, with the terminal in a partially inserted position, according to teachings of the present disclosure.

FIGS. 9A, 9B, and 9C are perspective, first cross-sectional, and second cross-sectional views, respectively, generally illustrating an embodiment of an electrical connector assembly, with a retainer in a second retainer position, according to teachings of the present disclosure.

FIGS. 10A, 10B, and 10C are perspective, first cross-sectional, and second cross-sectional views, respectively, generally illustrating an embodiment of an electrical connector assembly, with a retainer in a third retainer position, according to teachings of the present disclosure.

FIG. 11 is a flow diagram generally illustrating an embodiment of a method of operating an electrical connector according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

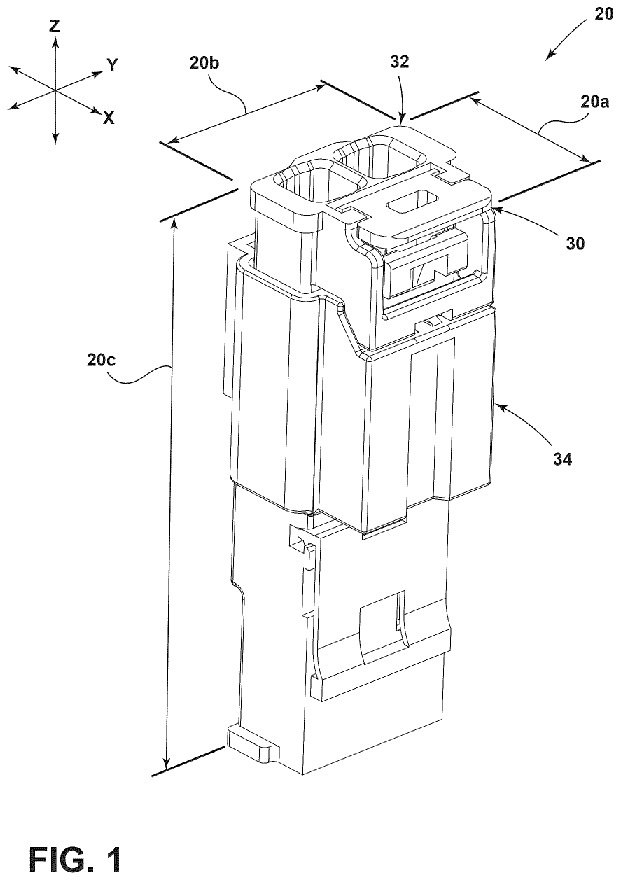

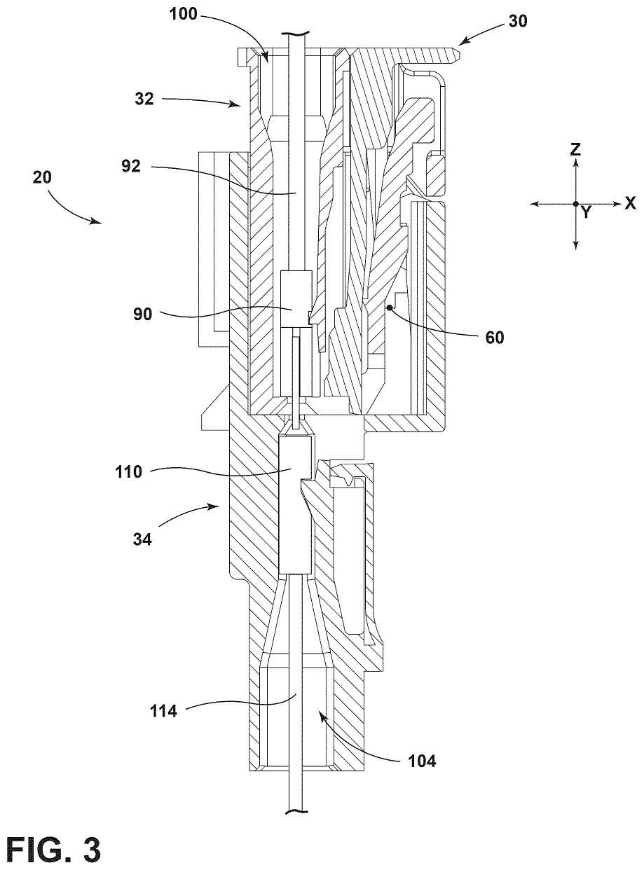

Referring to FIGS. 1-3, an electrical connector assembly 20 is illustrated with a retainer 30, a first connector 32, and a second connector 34. The first connector 32 and the second connector 34 are connectable to each other. The retainer 30 is slidably connectable to the first connector 32, such as to restrict relative movement between the first connector 32 and the second connector 34, and/or to restrict relative movement between the first connector 32 and one or more terminals 36 (FIG. 3). For example, the retainer 30 provides connector position assurance (CPA) or acts as a CPA device for the first connector 32 and the second connector 34, and provides terminal position assurance (TPA) or acts as a TPA device for the first connector 32 and the one or more terminals 36. The electrical connector assembly 20 includes a first dimension 20a (e.g., a length) measured in a first direction X, a second dimension 20b (e.g., a width) measured in a second direction Y, and a third dimension 20c (e.g., a depth) measured in a third direction Z. The first, second, and third directions X, Y, Z are perpendicular to each other. The electrical connector assembly 20 can be disposed in a variety of orientations. For example, the first direction X, the second direction Y, and the third direction Z can each be one of longitudinal, transverse, or vertical, or can be angled relative to one or more of vertical, longitudinal, or transverse directions. In a non-limiting example, the third direction Z is vertical and the retainer 30 is slidable downward into the first connector 32 and slidable upward away from and/or out of the first connector 32. The third dimension 20c can be greater than one or both of the first dimension 20a or the second dimension 20b.

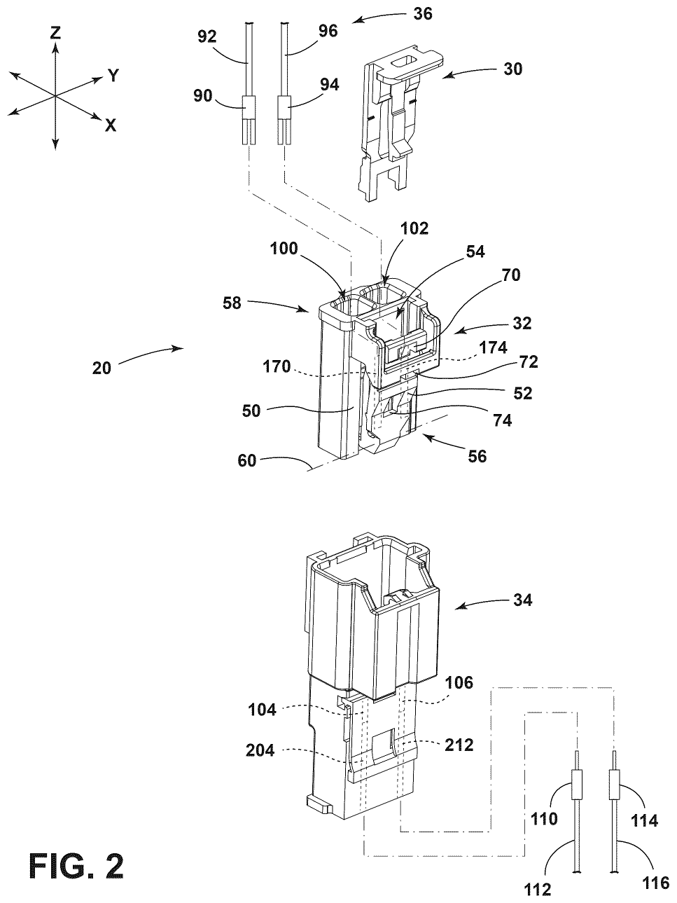

Referring to FIGS. 2 and 3, the first connector 32 includes a body 50 and a connector retaining arm 52 extending from the body 50 to at least partially define a retainer slot 54 configured to at least partially receive the retainer 30. For example, the connector retaining arm 52 extends from a first end 56 of the first connector 32 toward a second end 58 of the first connector 32. The first end 56 is configured for insertion into the second connector 34. The second end 58 is disposed opposite the first end 56. The connector retaining arm 52 is configured to deflect, at least to some degree, such as about an axis 60 disposed at or adjacent the first end 56. The axis 60 is parallel to the second direction Y. An assembly direction of the electrical connector assembly 20 is parallel with the third direction Z.

The connector retaining arm 52 includes a first aperture 70, a second aperture 72, and a third aperture 74, some or all of which can be through apertures. The first, second, and third apertures 70, 72, 74 are illustrated as rectangular apertures, but can include other configurations. The first, second, and third apertures 70, 72, 74 are configured to engage the retainer 30. The second aperture 72 is configured to engage the retainer 30 and the second connector 34. The one or more terminals 36 are provided as a first terminal 90 and a second terminal 94. The first terminal 90 is connected to a first wire 92. The second terminal 94 is connected to a second wire 96. The body 50 of the first connector 32 defines a first connector first terminal channel 100 and/or a first connector second terminal channel 102. The first connector first terminal channel 100 is configured to at least partially receive the first terminal 90 and the first wire 92. The first connector second terminal channel 102 is configured to at least partially receive the second terminal 94 and the second wire 96.

The second connector 34 includes a second connector first terminal channel 104 and/or a second connector second terminal channel 106 at least partially aligned with the first connector first terminal channel 100 and/or the first connector second terminal channel 102, respectively. The terminal channels 100, 102, 104, 106 extend parallel with the third direction Z. The electrical connector assembly 20 is illustrated with a third terminal 110 connected to a third wire 112 and with a fourth terminal 114 connected to a fourth wire 116. The second connector first terminal channel 104 is configured to at least partially receive the third terminal 110 and the third wire 112. The second connector second terminal channel 106 is configured to at least partially receive the fourth terminal 114 and the fourth wire 116.

Referring to FIG. 3, the electrical connector assembly 20 is illustrated with the first terminal 90 and at least portions of the first wire 92 disposed in the first connector first terminal channel 100, and with the third terminal 110 and at least portions of the third wire 112 disposed in the second connector first terminal channel 104. The third terminal 110 is illustrated as extending from the second connector 34 into the first connector 32 and into the first terminal 90 such that the first terminal 90 and the third terminal 110 are in contact and electrically connected to each other. Additionally or alternatively, the first terminal 90 extends into the second connector 34 and the third terminal 110. For example, the electrical connector assembly 20 can be utilized for connecting the first terminal 90 and first wire 92 with the third terminal 110 and the third wire 112. Referring again to FIG. 2, the second terminal 94 and/or the second wire 96 can be inserted into the first connector second terminal channel 102 in the same or a similar manner as the insertion of the first terminal 90 and the first wire 92, respectively, into the first connector first terminal channel 100. The fourth terminal 114 and the fourth wire 116 can be inserted into the second connector second terminal channel 106 in the same or a similar manner as the insertion of the third terminal 110 and the third wire 112, respectively, into the second connector first terminal channel 104. For example, the electrical connector assembly 20 can be utilized for connecting the first terminal 90 and first wire 92 with the third terminal 110 and the third wire 112, and connecting the second terminal 94 and the second wire 96 with the fourth terminal 114 and the fourth wire 116.

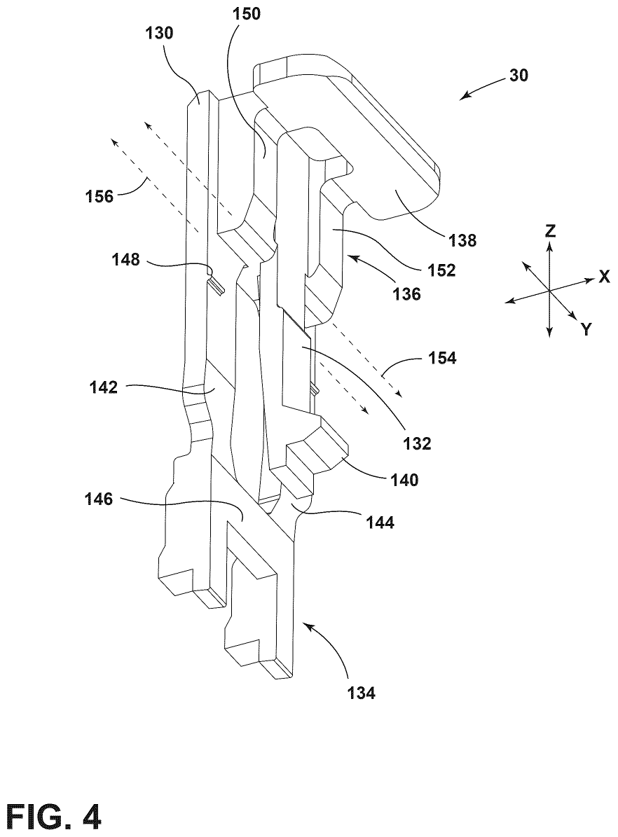

Referring to FIG. 4, a perspective view of the retainer 30 is illustrated. The retainer 30 includes a body 130, a first retainer arm 132, a second retainer arm 134, a protrusion 136, and a flange 138. The first retainer arm 132 extends from the body 130 generally in the assembly direction (e.g., the third direction Z). The first retainer arm 132 includes a retainer tab 140 that extends outward in the second direction Y from a distal end of the first retainer arm 132. The retainer tab 140 is configured to be disposed at least partially in the first aperture 70, the second aperture 72, or the third aperture 74 of the connector retaining arm 52 (FIG. 2), depending on the position of the retainer 30. The first retainer arm 132 is configured to deflect, at least to some degree, about an axis 154 that is parallel to the axis 60 (FIG. 2) and/or the second direction Y. The second retainer arm 134 extends from the body 130 generally in the third direction Z and is offset from the first retainer arm 132 in first direction X and/or the second direction Y. The second retainer arm 134 is illustrated with an H-shaped configuration including first and second projections 142, 144 connected by a middle section 146, but the second retainer arm 134 can include other configurations. The second retainer arm 134 is configured to deflect about an axis 156 that is parallel to the axis 60 (FIG. 2), the axis 154, and/or the second direction Y. The second retainer arm 134 optionally includes one or more retainer ribs 148 extending parallel to the first direction X. The protrusion 136 includes a first protrusion portion 150 and/or a second protrusion portion 152, which can be provided as portions of the body 130 that extend in the third direction Z and include an increased dimension in the second direction Y. The first protrusion portion 150 and the second protrusion portion 152 are spaced from each other in the second direction Y and/or are at least partially aligned in the third direction Z with the first and second projections 142, 144, respectively.

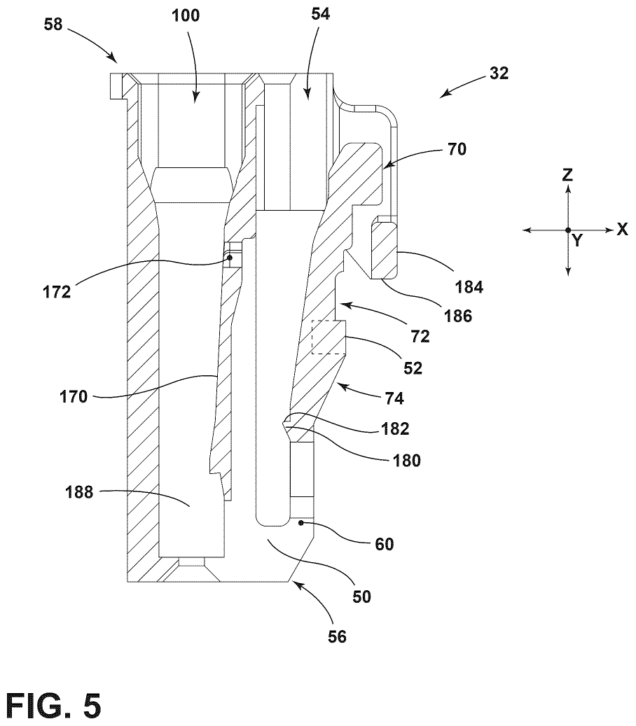

Referring to FIG. 5, a cross-sectional view of the first connector 32 illustrates the body 50, the connector retaining arm 52, the retainer slot 54, the first end 56, the second end 58, and the axis 60. The first connector 32 includes a terminal retaining arm 170 extending in the third direction Z and configured to deflect, at least to some degree, about an axis 172 parallel to the second direction Y, the axis 60, the axis 154 (FIG. 4), and/or the axis 156 (FIG. 4). For example, with respect to view of FIG. 5, the terminal retaining arm 170 deflects to the right during insertion of the first terminal 90 (FIG. 3) and/or deflects left in response to contact with the second retainer arm 134 (FIG. 3). The connector retaining arm 52 includes a rib 180 extending into the retainer slot 54 and including blocking surface 182 that is perpendicular to the third direction Z and faces the second end 58. The first aperture 70, the second aperture 72, and the third aperture 74 are spaced along the connector retaining arm 52 and are provided in a staggered configuration such that each is at least partially offset in in the first direction X from the others, with the first aperture 70 disposed the farthest outward and the third aperture 74 disposed the farther inward. The first connector includes a stop 184 extending from the body 50 and including a stop surface 186 that is perpendicular to the third direction Z and faces the first end 56. The stop surface 186 is configured to contact the second connector 34 to limit an insertion depth of the first connector 32 into the second connector 34. The view shown in FIG. 5 shows the first connector first terminal channel 100. The first connector second terminal channel 102 (FIG. 2) is disposed adjacent the first connector first terminal channel 100 in the second direction Y. The body 50 includes a channel wall 188 that is parallel to an X-Z plane and separates the first connector first terminal channel 100 from the first connector second terminal channel 102 (FIG. 2). Referring again to FIG. 2, the first connector 32 includes a second terminal retainer arm 174 (FIG. 2) that extends at least partially into the first connector second terminal channel 102 to restrict movement of the second terminal 94 (FIG. 2).

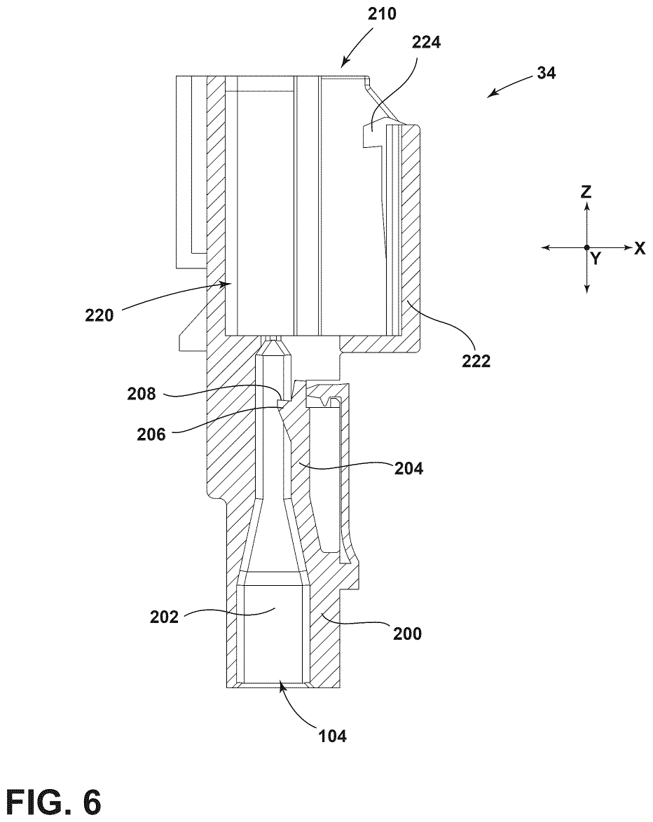

Referring to FIG. 6, a cross-sectional view of the second connector 34 is illustrated. The second connector 34 includes a body 200 that defines the second connector first terminal channel 104 and the second connector second terminal channel 106 (FIG. 2). The body 200 includes a channel wall 202 that is parallel to an X-Z plane and separates the second connector first terminal channel 104 from the second connector second terminal channel 106 (FIG. 2). The second connector 34 includes a terminal retaining arm 204 configured to restrict movement of the third terminal 110 relative to the second connector 34. The terminal retaining arm 204 includes a blocking rib 206 including a blocking surface 208. The blocking surface 208 is perpendicular to the third direction Z, faces a first end 210 of the body 200, and extends into the second connector first terminal channel 104 to engage and restrict movement of the third terminal 110 (FIG. 3). The second connector 34 can include a second terminal retaining arm 212 (FIG. 2) configured to restrict movement of the fourth terminal 114 (FIG. 2) and including the same or a similar configuration as the terminal retaining arm 204. The body 200 includes a connector receptacle 220 disposed at the first end 210 of the body 200 and configured to receive the first end 56 of the first connector 32 (FIG. 5). The connector receptacle 220 is at least partially defined by a peripheral wall 222 of the body 200. The body 200 includes a second connector tab 224 that extends inward from the peripheral wall 222 in the first direction X to engage the connector retaining arm 52, such as the second aperture 72 (FIG. 5), to couple the second connector 34 with the first connector 32 (FIG. 3).

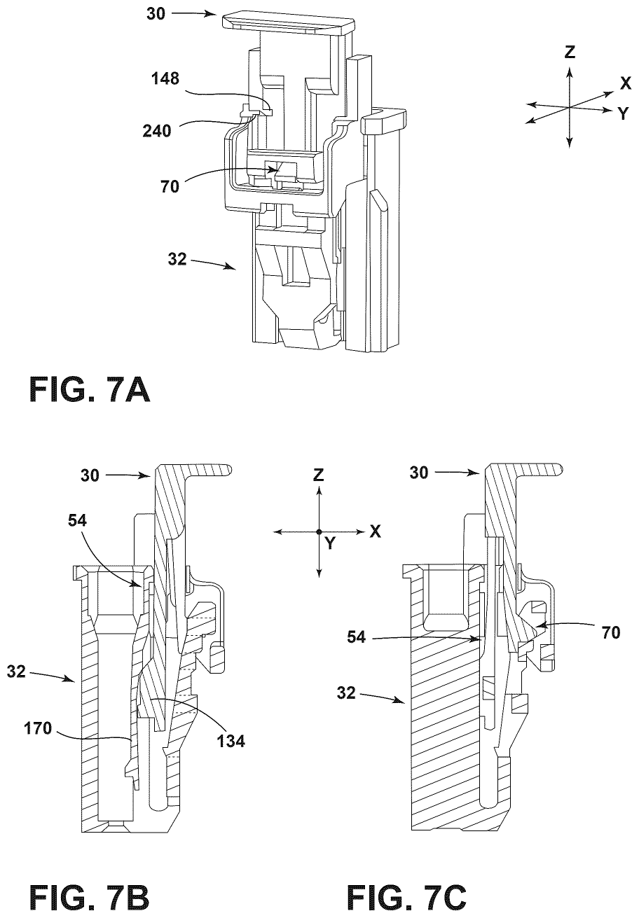

Referring to FIGS. 7A-7C, the retainer 30 is shown in a first retainer position relative to the first connector 32. In the first retainer position, a portion of the second retainer arm 134 is in contact with the terminal retaining arm 170. In the first retainer position, the retainer 30 is disposed partially in the retainer slot 54, and the first retainer arm 132 is disposed such that the retainer tab 140 is disposed at least partially in the first aperture 70, which restricts movement of the retainer 30 relative to the first connector 32. With examples in which the retainer 30 includes the one or more retainer ribs 148, the one or more retainer ribs 148 abut a second end surface 240 of the first connector 32, which restricts movement of the retainer 30 farther into the first connector 32. For example, the one or more retainer ribs 148 are configured to increase a minimum insertion force for moving the retainer 30 farther into the first connector 32 and/or to limit unintended movement of the retainer 30 farther into the first connector 32. The one or more retainer ribs 148 and/or the second end surface 240 includes a tapered surface to engage the other.

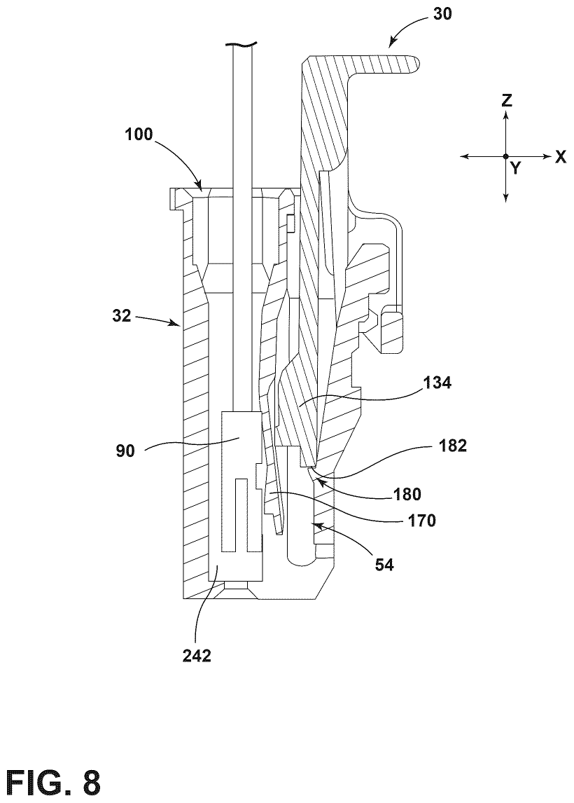

Referring to FIG. 8, the retainer 30 is shown in the first retainer position and the first terminal 90 is shown in a partially inserted position in which the first terminal 90 is spaced in the third direction Z from a channel end surface 242 of the first connector first terminal channel 100. Insertion of the first terminal 90 to the partially inserted position causes the terminal retaining arm 170 to deflect away from the first connector first terminal channel 100 in the first direction X and into the retainer slot 54 (e.g., to the right in FIG. 8). This movement of the terminal retaining arm 170 reduces the dimension of the retainer slot 54, restricting and/or preventing further insertion of the retainer 30. Additionally or alternatively, the movement of the terminal retaining arm 170 can cause the second retainer arm 134 to move into alignment and/or contact with the blocking surface 182 of the rib 180, which restricts and/or prevents further insertion of the retainer 30. Restriction of further insertion of the retainer 30 provides an indication that the first terminal 90 is in the partially inserted position (e.g., is improperly inserted). For example, the retainer 30 provides terminal position assurance (TPA) for the first terminal 90 relative to the first connector 32.

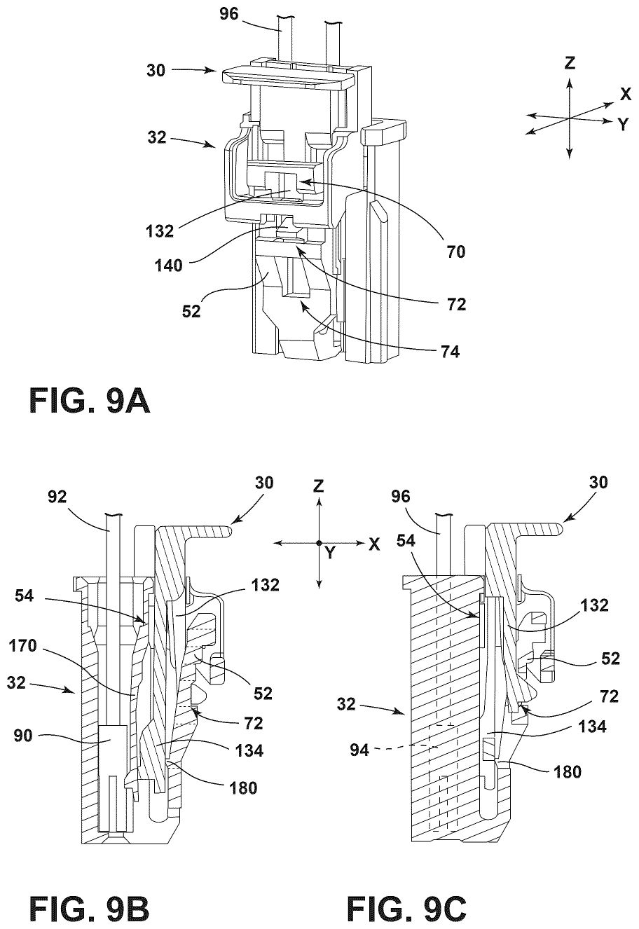

The first terminal 90 can be inserted further into the first connector first terminal channel 100 until the first terminal 90 is in a fully inserted position in which the first terminal 90 contacts the channel end surface 242, as shown in FIGS. 9A-9C. In the fully inserted position, the first terminal 90 is positioned to allow the terminal retaining arm 170 to deflect back toward the first connector first terminal channel 100, which allows the second retainer arm 134 to disengage the rib 180 and move farther into the first connector 32. Insertion of the second terminal 94 of FIG. 2 can be conducted in the same or a similar manner. For example, in a partially inserted position of the second terminal 94, the second terminal 94 deflects the second terminal retaining arm 174 such that the second terminal retaining arm 174 blocks movement of the retainer 30 to the second retainer position. In a fully inserted position of the second terminal 94, the second terminal retaining arm 174 is engaged with the second terminal 94 to restrict relative movement of the second terminal 94 and the first connector 32 (e.g., restrict removal of the second terminal 94). For example, the retainer 30 provides TPA for the first terminal 90 and/or the second terminal 94.

Referring to FIGS. 9A-9C, the retainer 30 is shown in a second retainer position relative to the first connector 32 (e.g., a partially locked position) in which the retainer 30 restricts movement of the first terminal 90 relative to the first connector 32 and in which the retainer 30 does not substantially restrict movement of the second connector 34 (FIG. 2). In the second retainer position, the second retainer arm 134 is in contact with the terminal retaining arm 170 and with the connector retaining arm 52 such that retainer 30 restricts (e.g., prevents) movement of the terminal retaining arm 170 in the first direction X (e.g., to the right in FIG. 9B), which restricts the terminal retaining arm 170 from disengaging the first terminal 90, restricting removal of the first terminal 90 from the first connector 32 (e.g., the first terminal 90 is locked with the first connector 32). The second terminal 94 can be locked in a similar manner.

In the second retainer position, the first retainer arm 132 is disposed such that the retainer tab 140 is disposed at least partially in the second aperture 72, which restricts movement of the retainer 30 relative to the first connector 32. Moving the retainer 30 from the first retainer position to the second retainer position can include applying a force in the third direction Z (e.g., downward in FIGS. 9A-9C) to the flange 138 that overcomes the frictional forces between the retainer 30 and the first connector 32, such as between the retainer tab 140 and the connector retaining arm 52 and/or between the one or more retainer ribs 148 (FIG. 4) and the body 50. Optionally, at least one of the retainer tab 140 or the connector retaining arm 52 includes a tapered surface to reduce friction therebetween and facilitate further insertion of the retainer 30. Additionally or alternatively, moving the retainer 30 from the first retainer position to the second retainer position can include applying a second force in the first direction X (e.g., to the left in FIGS. 9A-9C) to the first retainer arm 132, such as to the retainer tab 140, to move the retainer tab at least partially into the retainer slot 54 and at least partially out of the second aperture 72, which can reduce friction between the retainer 30 and the first connector 32 to facilitate further insertion of the retainer 30.

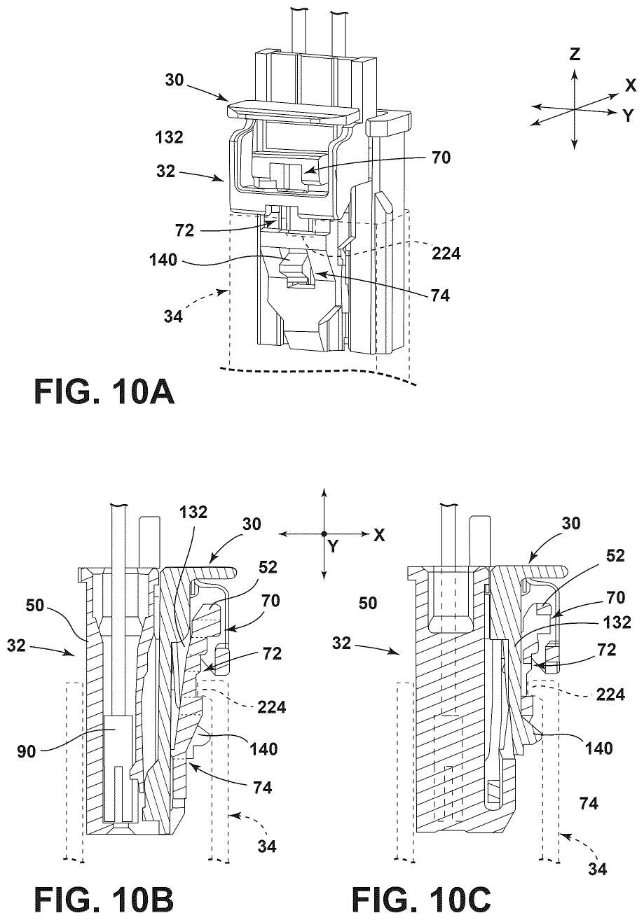

Referring to FIGS. 10A-10C, the retainer 30 is shown in a third retainer position relative to the first connector 32 (e.g., a locked position) in which the retainer 30 restricts movement of the first terminal 90 relative to the first connector 32 and in which the retainer 30 restricts movement of the second connector 34. In the third retainer position, the second retainer arm 134 is in contact with the terminal retaining arm 170 and with the body 50 and/or the connector retaining arm 52 such that retainer 30 restricts (e.g., prevents) the terminal retaining arm 170 in the first direction X in the same or similar manner as the second retainer position, which restricts the terminal retaining arm 170 from disengaging the first terminal 90, restricting removal of the first terminal 90 from the first connector 32. In the third retainer position, the first retainer arm 132 is disposed such that the retainer tab 140 is disposed at least partially in the third aperture 74, which restricts movement of the retainer 30 relative to the first connector 32. Moving the retainer 30 from the second retainer position to the third retainer position can include inserting the first connector 32 into the connector receptacle 220 such that the second connector tab 224 engages the connector retainer arm 52 at the second aperture 72 and moves the retainer tab 140 out of the second aperture 72 (e.g., to the left in FIGS. 10A-10C), and then applying a force in the third direction Z (e.g., downward in FIGS. 10A-10C) to the flange 138 that overcomes the frictional forces between the retainer 30 and the first connector 32. For example, in the connected position of the second connector 34, such as shown in FIGS. 10A-10C, the second connector 34 is configured to disengage the retainer 30 (e.g., the first retainer arm 132) from the connector retaining arm 52 (e.g., the second aperture 72) to facilitate and/or allow the retainer 30 to move from the second retainer position to the third retainer position. The retainer 30 being disposed in the third retainer position also provides an indication that the second connector 34 is properly connected to the first connector 32 (e.g., for CPA functionality).

In the third retainer position, the protrusion 136 is disposed between the connector retaining arm 52 and the body 50 to restrict movement of the connector retaining arm 52 in the first direction X (e.g., to the left in FIGS. 10A-10C), which can prevent the second connector tab 224 from disengaging the connector retaining arm 52. For example, disengaging the second connector tab 224 from the connector retainer arm 52 can involve moving (e.g., deflecting) the connector retaining arm 52 in the first direction X away from the second connector tab 224. With retainer 30 in the third retainer position and the first connector 32 inserted into the second connector 34, the second connector 34 covers the third aperture 74 such that the third aperture 74 is substantially inaccessible, the second connector 34 covers at least a portion of the second aperture 72 (e.g., via the second connector tab 224), and/or the first aperture 70 is not covered by the second connector 34. For example, the first retainer arm 132 is accessible through the first aperture 70 and/or the second aperture 72 to allow for moving the first retainer arm 132 out of engagement with the connector retaining arm 52 (e.g., to move the retainer tab 140 out of the third aperture 74), which can allow for the retainer 30 to be moved to the second retainer position, which can allow for the connector retaining arm 52 to deflect away from the second connector tab 224 and then for the first connector 32 to be removed and/or disengaged from the second connector 34.

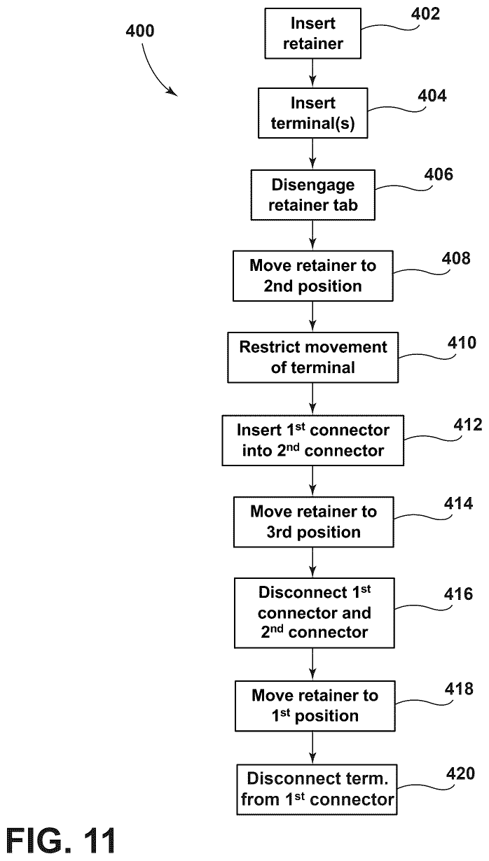

Referring to FIG. 11, a method 400 of operating the electrical connector assembly 20 of FIGS. 1-10 includes inserting the retainer 30 partially into the retainer slot 54 of the first connector 32 (block 402).

The method 400 includes inserting one or more terminals, such as the first terminal 90, the second terminal 94, the third terminal 110, and/or the fourth terminal 114, into one or more terminal channels, such as the terminal channels 100-106, such that the one or more terminals are disposed in fully inserted positions (block 404).

The method 400 includes moving a retainer arm of the retainer 30, such as the first retainer arm 132, to disengage the retainer tab 140 from the first aperture 70 of the connector retaining arm 52 of the first connector 32 (block 406).

The method 400 includes moving the retainer 30 from the first retainer position to the second retainer position such that the retainer tab 140 is engaged with the second aperture 72 (block 408). Moving the retainer 30 from the first retainer position to the second retainer position includes sliding the retainer 30 farther into to the first connector 32.

The method 400 includes restricting movement of one or more terminals, such as the first and second terminals 90, 94, relative to the first connector 32 (block 410), such as via the retainer 30 restricting movement of the first and second terminal retaining arms 170, 174 of the first connector 32.

The method 400 includes inserting the first connector 32 at least partially into the second connector 34 such that the second connector 34 moves the retainer tab 140 out of the second aperture 72 and the second connector tab 224 engages the second aperture 72 to restrict relative movement of the first connector 32 and the second connector 34 (block 412).

The method 400 includes, after second connector 34 moves the retainer tab 140 out of the second aperture 72, moving the retainer 30 from the second retainer position to the third retainer position such that the retainer 30 restricts movement of the connector retaining arm 52 to restrict disengagement of the second connector tab 224 from the second aperture 72 (block 414) (e.g., the retainer 30 provide CPA for the connecting of the first connector 32 and the second connector 34). For example, in the third retainer position, the protrusion 136 is disposed between the connector retaining arm 52 and the body 50 to restrict movement of the connector retaining arm 52 in the first direction X, which can prevent the second connector tab 224 from disengaging the connector retaining arm 52.

Optionally, the method 400 further comprises disconnecting the first connector 32 and the second connector 34 (block 416), which can include moving the retainer tab out of the third aperture, moving the retainer from the third retainer position to the second retainer position, and disconnecting the first connector from the second connector. Moving the retainer tab 140 out of the third aperture 74 includes contacting the connector retaining arm 52 through at least one of the first aperture 70 or the second aperture 72.

Optionally, the method 400 includes moving the retainer 30 from the second retainer position to the first retainer position (block 418), and disconnecting the terminal from the first connector 32 (block 420).

Optionally, the electrical connector assembly 20 is transported after the retainer 30 is inserted into the first connector 32 in block 402 and the method 400 includes temporarily inserting the first connector 32 into the second connector 34 such that the retainer, the first connector 32, and the second connector 34 are at least temporarily connected together for transport (e.g., to a final assembly location). The first connector 32 can be removed from the second connector 34 prior to conducting block 408.

Optionally, one or more of the retainer 30, the first connector 32, or the second connector 34 are monolithic components (e.g., single, unitary components) and/or comprise electrically insulating material, such as plastic.

Embodiments of the electrical connector assembly 20 can be less complicated and/or include fewer components than other connector assemblies. For example, the retainer 30 can provide both TPA and CPA, instead of having separate components assembled in different ways to provide TPA and CPA. Additionally or alternatively, the electrical connector assembly 20 can maintain the retainer 30 in an unlocked and engaged position (e.g., the first retainer position) such that unintended removal or loss of the retainer 30 is limited and/or such that unintended insertion of the retainer 30 farther into the first connector 32 is limited, some or all of which can facilitate assembly.

The instant disclosure includes the following non-limiting embodiments:

An electrical connector assembly, comprising: a first connector; a second connector connectable with the first connector; and a retainer slidably connectable to the first connector to restrict relative movement between the first connector and the second connector and to restrict relative movement between the first connector and a terminal.

The electrical connector assembly of any preceding embodiment, wherein the retainer is monolithic.

The electrical connector assembly of any preceding embodiment, wherein the retainer is configured to provide terminal position assurance (TPA) for the first connector relative to the terminal and provide connector position assurance (CPA) for the first connector and the second connector.

The electrical connector assembly of any preceding embodiment, wherein the retainer includes a first retainer position, a second retainer position, and a third retainer position relative to the first connector.

The electrical connector assembly of any preceding embodiment, wherein, the first retainer position is an unlocked position; and in the second retainer position, the retainer is configured to restrict movement of the terminal relative to the first connector.

The electrical connector assembly of any preceding embodiment, wherein, in the first retainer position, the retainer is engaged with the first connector such that relative movement of the retainer and the first connector is restricted.

The electrical connector assembly of any preceding embodiment, wherein, in the third retainer position, the retainer is configured to restrict movement of the terminal and restrict movement of the second connector relative to the first connector.

The electrical connector assembly of any preceding embodiment, wherein the first connector includes a connector retaining arm configured to retain the second connector; and in the third retainer position, the retainer is configured to restrict movement of the connector retaining arm to restrict movement of the second connector.

The electrical connector assembly of any preceding embodiment, wherein the first connector includes a terminal retaining arm configured to retain the terminal; and in the second retainer position and the third retainer position, the retainer is configured to restrict movement of the terminal retaining arm to restrict movement of the terminal.

The electrical connector assembly of any preceding embodiment, wherein the connector retaining arm includes a first aperture, a second aperture, and a third aperture; the retainer includes a retainer arm including a retainer tab; in the first retainer position, the retainer tab is disposed at least partially in the first aperture; in the second retainer position, the retainer tab is disposed at least partially in the second aperture; and in the third retainer position, the retainer tab is disposed at least partially in the third aperture.

The electrical connector assembly of any preceding embodiment, wherein the connector retaining arm, the terminal retaining arm, and the retainer arm are configured to deflect about parallel axes.

The electrical connector assembly of any preceding embodiment, wherein the retainer arm is a first retainer arm; the retainer includes a second retainer arm configured to contact the terminal retaining arm; and the connector retaining arm, the terminal retaining arm, the first retainer arm, and the second retainer arm are configured to deflect about parallel axes.

The electrical connector assembly of any preceding embodiment, wherein, in the third retainer position, the retainer arm is accessible through at least one of the first aperture or the second aperture to remove the retainer tab from the third aperture to facilitate movement of the retainer out of the third retainer position.

The electrical connector assembly of any preceding embodiment, wherein, with the retainer in the third retainer position and the second connector connected with the first connector, the third aperture is covered by the second connector.

The electrical connector assembly of any preceding embodiment, wherein the second connector includes a second connector tab configured to engage the connector retaining arm and extend at least partially into the second aperture.

The electrical connector assembly of any preceding embodiment, wherein the second connector tab is configured to contact the retainer tab to disengage the retainer tab from the connector retaining arm and facilitate movement of the retainer to the third retainer position.

The electrical connector assembly of any preceding embodiment, wherein the retainer includes a retainer protrusion; and in the third retainer position, the retainer protrusion restricts movement of the connector retaining arm.

The electrical connector assembly of any preceding embodiment, further comprising the terminal; wherein the retainer includes a first retainer position, a second retainer position, and a third retainer position relative to the first connector; in the second retainer position, the retainer is configured to restrict movement of the terminal relative to the first connector; in the third retainer position, the retainer is configured to restrict movement of the terminal and restrict movement of the second connector relative to the first connector; the terminal includes an inserted position (e.g., a fully inserted position) and a partially inserted position; in the fully inserted position, a terminal retaining arm of the first connector is configured to restrict movement of the terminal; in the partially inserted position, the terminal is configured to restrict movement of the retainer from the first retainer position to the second retainer position; in the second retainer position, the first connector is configured to restrict movement of the retainer from the second retainer position to the third retainer position; and in a connected position of the second connector, the second connector is configured to disengage the retainer from the first connector to allow the retainer to move from the second retainer position to the third retainer position.

The electrical connector assembly of any preceding embodiment, wherein, in the partially inserted position of the terminal, the terminal is disposed such that at least one of the terminal retaining arm or a rib of a connector retaining arm of the first connector restricts movement of the retainer from the first retainer position to the second retainer position.

The electrical connector assembly of any preceding embodiment, further comprising the terminal; wherein the terminal is a first terminal; the electrical connector assembly further comprises a second terminal; the first terminal is disposed at least partially in a first connector terminal channel of the first connector; the second terminal is disposed at least partially in a second connector terminal channel of the second connector; and the first terminal is in contact with the second terminal.

A method of operating the electrical connector assembly of any preceding embodiment, the method comprising: inserting the terminal into a terminal channel of the first connector such that the terminal is disposed in a terminal inserted position; moving the retainer arm to disengage the retainer tab from the first aperture of the connector retaining arm of the first connector; moving the retainer from the first retainer position to the second retainer position such that the retainer tab is engaged with the second aperture; restricting movement of the terminal retaining arm of the first connector via the retainer to restrict movement of the terminal relative to the first connector; inserting the first connector at least partially into the second connector such that the second connector moves the retainer tab out of the second aperture and a second connector tab engages the second aperture to restrict relative movement of the first connector and the second connector; and moving the retainer from the second retainer position to the third retainer position such that the retainer restricts movement of the connector retaining arm to restrict disengagement of the second connector tab from the second aperture.

The method of any preceding embodiment, wherein moving the retainer from the first retainer position to the second retainer position includes sliding the retainer farther into to the first connector.

The method of any preceding embodiment, further comprising moving the retainer tab out of the third aperture; moving the retainer from the third retainer position to the second retainer position; and disconnecting the first connector from the second connector.

The method of any preceding embodiment, wherein moving the retainer tab out of the third aperture includes contacting the retainer arm through at least one of the first aperture or the second aperture.

The method of any preceding embodiment, further comprising moving the retainer from the second retainer position to the first retainer position; and disconnecting the terminal from the first connector.

A vehicle comprising the assembly of any preceding embodiment.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. The terms “restrict” and “limit” can include partial restrictions and limits and can include complete restrictions and limits (e.g., prevention). For example, for a first component described as restricting movement of a second component, the first component can partially restrict (e.g., impair, reduce, constrain, etc.) movement of the second component or completely restrict (e.g., prevent) movement of the second component.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

What is claimed is:

1. An electrical connector assembly, comprising:
a first connector;
a second connector connectable with the first connector; and
a retainer slidably connectable to the first connector to restrict relative movement between the first connector and the second connector to restrict relative movement between the first connector and a terminal.

2. The electrical connector assembly of claim 1, wherein the retainer is monolithic.

3. The electrical connector assembly of claim 2, wherein the retainer is configured to provide terminal position assurance (TPA) for the first connector relative and the terminal and provide connector position assurance (CPA) for the first connector and the second connector.

4. The electrical connector assembly of claim 1, wherein the retainer includes a first retainer position, a second retainer position, and a third retainer position relative to the first connector.

5. The electrical connector assembly of claim 4, wherein, the first retainer position is an unlocked position; and
in the second retainer position, the retainer is configured to restrict movement of the terminal relative to the first connector.

6. The electrical connector assembly of claim 5, wherein, in the first retainer position, the retainer is engaged with the first connector such that relative movement of the retainer and the first connector is restricted.

7. The electrical connector assembly of claim 5, wherein, in the third retainer position, the retainer is configured to restrict movement of the terminal and restrict movement of the second connector relative to the first connector.

8. The electrical connector assembly of claim 7, wherein the first connector includes a connector retaining arm configured to retain the second connector; and
in the third retainer position, the retainer is configured to restrict movement of the connector retaining arm to restrict movement of the second connector.

9. The electrical connector assembly of claim 8, wherein the first connector includes a terminal retaining arm configured to retain the terminal; and
in the second retainer position and the third retainer position, the retainer is configured to restrict movement of the terminal retaining arm to restrict movement of the terminal.

10. The electrical connector assembly of claim 9, wherein the connector retaining arm includes a first aperture, a second aperture, and a third aperture;
the retainer includes a retainer arm including a retainer tab;
in the first retainer position, the retainer tab is disposed at least partially in the first aperture;
in the second retainer position, the retainer tab is disposed at least partially in the second aperture; and
in the third retainer position, the retainer tab is disposed at least partially in the third aperture.

11. The electrical connector assembly of claim 10, wherein the connector retaining arm, the terminal retaining arm, and the retainer arm are configured to deflect about parallel axes.

12. The electrical connector assembly of claim 10, wherein the retainer arm is a first retainer arm;
the retainer includes a second retainer arm configured to contact the terminal retaining arm; and
the connector retaining arm, the terminal retaining arm, the first retainer arm, and the second retainer arm are configured to deflect about parallel axes.

13. The electrical connector assembly of claim 10, wherein, in the third retainer position, the retainer arm is accessible through at least one of the first aperture or the second aperture to remove the retainer tab from the third aperture to facilitate movement of the retainer out of the third retainer position.

14. The electrical connector assembly of claim 13, wherein, with the retainer in the third retainer position and the second connector connected with the first connector, the third aperture is covered by the second connector.

15. The electrical connector assembly of claim 10, wherein the second connector includes a second connector tab configured to engage the connector retaining arm and extend at least partially into the second aperture.

16. The electrical connector assembly of claim 15, wherein the second connector tab is configured to contact the retainer tab to disengage the retainer tab from the connector retaining arm and facilitate movement of the retainer to the third retainer position.

17. The electrical connector assembly of claim 16, wherein the retainer includes a retainer protrusion; and
in the third retainer position, the retainer protrusion restricts movement of the connector retaining arm.

18. The electrical connector assembly of claim 1, further comprising the terminal;
wherein the retainer includes a first retainer position, a second retainer position, and a third retainer position relative to the first connector;
in the second retainer position, the retainer is configured to restrict movement of the terminal relative to the first connector;
in the third retainer position, the retainer is configured to restrict movement of the terminal and restrict movement of the second connector relative to the first connector;
the terminal includes a fully inserted position and a partially inserted position;
in the fully inserted position, a terminal retaining arm of the first connector is configured to restrict movement of the terminal;
in the partially inserted position, the terminal is configured to restrict movement of the retainer from the first retainer position to the second retainer position;
in the second retainer position, the first connector is configured to restrict movement of the retainer from the second retainer position to the third retainer position; and
in a connected position of the second connector, the second connector is configured to disengage the retainer from the first connector to allow the retainer to move from the second retainer position to the third retainer position.

19. The electrical connector assembly of claim 18, wherein, in the partially inserted position of the terminal, the terminal is disposed such that at least one of the terminal retaining arm or a rib of a connector retaining arm of the first connector restricts movement of the retainer from the first retainer position to the second retainer position.

20. The electrical connector assembly of claim 1, further comprising the terminal;
wherein the terminal is a first terminal;
the electrical connector assembly further comprises a second terminal;
the first terminal is disposed at least partially in a first connector terminal channel of the first connector;
the second terminal is disposed at least partially in a second connector terminal channel of the second connector; and
the first terminal is in contact with the second terminal.
